(19) United States
(12) Patent Application Publication
(10) Pub. No.: US 2007/0220172 A1
(43) Pub. Date: Sep. 20, 2007

(54) Method of synchronizing screens

(76) Inventor: Terry K. Gilliam, North Kingstown, RI (US)

Correspondence Address: DEVINE, MILLIMET & BRANCH, P.A., 111 AMHERST STREET, BOX 719, MANCHESTER, NH, 03105, US

(21) Appl. No.: 11/713,917

(22) Filed: Mar. 5, 2007

Related U.S. Application Data
(60) Provisional application No. 60/779,257, filed on Mar. 3, 2006.

(51) Int. Cl. G06F 15/16

(52) U.S. Cl. 709/248

(57) ABSTRACT

A method of synchronizing screens in a meeting. The method includes updating a database with the status of at least one participant, synchronizing the view of a facilitator with the view of at least one participant, calling a web service at timed intervals, checking the status of each participant, determining if the participant is running the selected activity, and, if the participant is not running the selected activity, redirecting the participant to the selected activity.

### CROSS-REFERENCE TO RELATED APPLICATIONS

The present application claims the benefit of provisional application Ser. No. 60/779,257 filed Mar. 3, 2006, which is incorporated herein by reference.

### TECHNICAL FIELD

The present invention relates to the field of screen synchronization.

### SUMMARY

In accordance with one aspect of the present invention, a method of synchronizing screens in a meeting. The method includes updating a database with the status of at least one participant, synchronizing the view of a facilitator with the view of at least one participant, calling a web service at timed intervals, checking the status of each participant, determining if the participant is running the selected activity, and, if the participant is not running the selected activity, redirecting the participant to the selected activity.

### BRIEF DESCRIPTION OF THE DRAWINGS

These and other features and advantages of the present invention will be better understood by reading the following detailed description, taken together with the drawings wherein:

FIG. 1 is a schematic diagram of the preferred embodiment of invention.

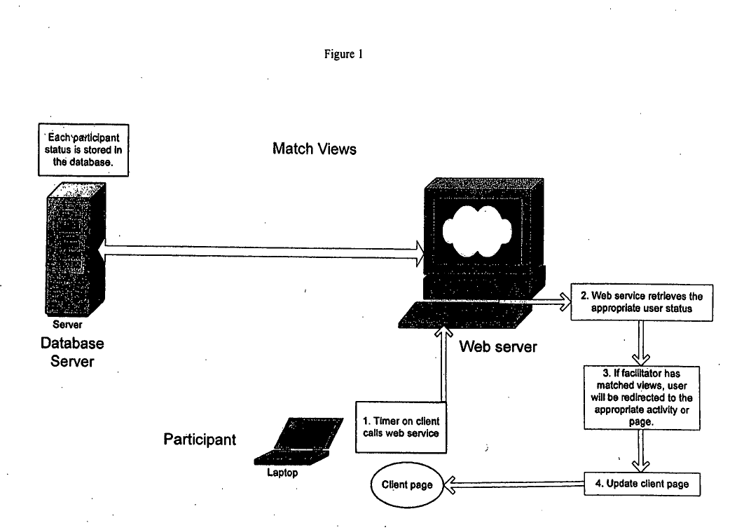

### DETAILED DESCRIPTION OF THE PREFERRED EMBODIMENTS

The present invention is a used by the facilitator to synchronize screens with participants in meetings. The term “facilitator” and the term “screen” refer to computers. The present invention can be used from the main agenda and from within any activity within the meeting. The invention allows the facilitator to let the meeting participants view the same screen as that of the facilitator. Upon selecting which participants to match views with, the selected participants will be automatically redirected to the activity which the facilitator is accessing and viewing. In order to use the present invention, the following steps must be taken by the facilitator machine:

1. The facilitator must be logged into the meeting and viewing either the main agenda or within the activity.

2. The facilitator can click on Match Views and the Match Views page will open up separately.

3. On the opened window, the facilitator will be able to view a list of all the participants in the meeting.

4. The facilitator can select from the participant list which of the participants to match views with. By default, all the participants are selected.

5. The facilitator will now be able to click to match views with the selected participants.

The present method is processed by a computer processor:

Below is a description of the steps in the method.

1. The status of each participant is stored in the system database. The database keeps track of where in the application each participant is at.

2. Upon selecting match views, a function is called to update the status of the concerned users so that it matches the Match Views destination.

3. In the background on the client browser, a timer is running. On the time out event of the timer, an interval of 3 seconds, a web service will be called.

4. This web service being called is responsible for checking the status of each user. The web service will check if the user is in the correct activity. Otherwise, the user will be redirected to his/her appropriate activity or page.

The following technologies are used in the present invention: ASP.Net; VB.Net; JavaScript; and SQL Server 2000.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

1. A method of synchronizing screens in a meeting comprising the steps of:
updating a database with status of at least one participant;
synchronizing view of a facilitator with view of said at least one participant;
calling a web service at timed intervals;
checking status of each of said participant;
determining if said participant is running a selected activity; and
if said participant is not running said selected activity, redirecting said participant to said selected activity.
